(19) United States
(12) Patent Application Publication
(10) Pub. No.: US 2019/0211817 A1
(43) Pub. Date: Jul. 11, 2019

(54) HIGH-PRESSURE POSITIVE DISPLACEMENT PLUNGER PUMP

(71) Applicant: Graco Minnesota Inc., Minneapolis, MN (US)

(72) Inventors: Bradley H. Hines, Andover, MN (US); Brian W. Koehn, Minneapolis, MN (US)

(21) Appl. No.: 16/242,497

(22) Filed: Jan. 8, 2019

Related U.S. Application Data
(60) Provisional application No. 62/615,115, filed on Jan. 9, 2018.

(51) Int. Cl. F04B 45/047; F04B 9/135; F04B 1/14; F04B 17/03; F04B 27/10; F04B 45/04

(52) U.S. Cl. CPC F04B 45/047; F04B 9/135; F04B 1/14; F05B 2210/12; F04B 27/10; F04B 45/041; F04B 2203/04; F04B 17/03

(57) ABSTRACT

A drive system for a pump includes a housing defining an internal pressure chamber, a working fluid disposed within and charging the internal pressure chamber, and a reciprocating member disposed within the internal pressure chamber. A fluid displacement component has first and second surfaces. The first surface is configured to contact the working fluid and the second surface is configured to contact the process fluid. The area of the first surface is greater than the area of the second surface. A pull extends between and connects the reciprocating member and the fluid displacement component. The pull mechanically transfers a pulling force from the reciprocating member to the fluid displacement component.

### CROSS-REFERENCE TO RELATED APPLICATION(S)

This application claims priority to U.S. Provisional Application No. 62/615,115 filed on Jan. 9, 2018, and entitled “HIGH PRESSURE POSITIVE DISPLACEMENT PLUNGER PUMP,” the disclosure of which is hereby incorporated by reference in its entirety.

### BACKGROUND

This disclosure relates to positive displacement pumps and more particularly to an internal drive system and displacement mechanism for positive displacement pumps.

Positive displacement pumps discharge a process fluid at a selected flow rate. In a typical positive displacement pump, a fluid displacement member, usually a piston or diaphragm, drives the process fluid through the pump. When the fluid displacement member is drawn in, a suction condition is created in the fluid flow path, which draws process fluid into a fluid cavity from the inlet manifold. The fluid displacement member then reverses direction and forces the process fluid out of the fluid cavity through the outlet manifold.

Air operated double displacement pumps typically employ diaphragms as the fluid displacement members. In an air operated double displacement pump, the two diaphragms are joined by a shaft, and compressed air is the working fluid in the pump. Compressed air is supplied to one of two diaphragm chambers, associated with the respective diaphragms. When compressed air is supplied to the first diaphragm chamber, the first diaphragm is deflected into the first fluid cavity, which discharges the process fluid from that fluid cavity. Simultaneously, the first diaphragm pulls the shaft, which is connected to the second diaphragm, drawing the second diaphragm in and pulling process fluid into the second fluid cavity. The compressed air that had previously driven the second diaphragm is typically exhausted to the atmosphere.

The delivery of compressed air is controlled by an air valve, and the air valve is usually mechanically actuated by the diaphragms. Thus, one diaphragm is pulled in until it causes the actuator to toggle the air valve. Toggling the air valve exhausts the compressed air from the first diaphragm chamber to the atmosphere and introduces fresh compressed air to the second diaphragm chamber, thus causing a reciprocating movement of the respective diaphragms. Alternatively, the first and second fluid displacement members could be pistons instead of diaphragms, and the pump would operate in the same manner.

Hydraulically driven double displacement pumps utilize hydraulic fluid as the working fluid, which allows the pump to operate at much higher pressures than an air driven pump. In a hydraulically driven double displacement pump, hydraulic fluid drives one fluid displacement member into a pumping stroke. That fluid displacement member is mechanically attached to the second fluid displacement member and thereby pulls the second fluid displacement member into a suction stroke. The hydraulic fluid is typically exhausted back to the hydraulic circuit as the fluid displacement members are pulled through the suction stroke. The use of hydraulic fluid and pistons enables the pump to operate at higher pressures than those achievable by an air driven diaphragm pump.

Alternatively, double diaphragm displacement pumps may be mechanically operated, without the use of air or hydraulic fluid. In these cases, the operation of the pump is essentially similar to an air operated double displacement pump, except compressed air is not used to drive the system. Instead, a reciprocating drive is mechanically connected to both the first fluid displacement member and the second fluid displacement member, and the reciprocating drive drives the two fluid displacement members into suction and pumping strokes.

### SUMMARY

According to one aspect of the present disclosure, a pump for pumping a process fluid includes a housing defining an internal pressure chamber, the internal pressure chamber configured to contain a working fluid; a reciprocating member disposed within the internal pressure chamber; a fluid displacement component having a first surface and a second surface, the first surface configured to contact the working fluid and the second surface configured to contact the process fluid, wherein the fluid displacement component is configured such that pressure exerted on the first surface by the working fluid moves the second surface in a first direction towards the process fluid to expel the process fluid downstream, and wherein the area of the first surface is greater than the area of the second surface; and a pull extending between the reciprocating member and the fluid displacement component, the pull mechanically transferring a pulling force from the reciprocating member to the fluid displacement component to move the fluid displacement component in a second direction that is the opposite of the first direction, wherein the pull does not mechanically transfer a pushing force from the reciprocating member to the fluid displacement component when the reciprocating member moves in the first direction.

According to another aspect of the present disclosure, a pump for pumping a process fluid includes a housing defining an internal pressure chamber, the internal pressure chamber configured to contain a working fluid; a reciprocating member; a fluid displacement component having a first surface and a second surface, the first surface configured to contact the working fluid and the second surface configured to contact the process fluid, wherein the fluid displacement component is configured such that pressure exerted on the first surface by the working fluid moves the second surface in a first direction to expel the process fluid, and wherein the area of the first surface is greater than the area of the second surface; and a pull that links the reciprocating member to the fluid displacement component, the pull mechanically transferring a pulling force from the reciprocating member to the fluid displacement component to move the fluid displacement component in a second direction.

### BRIEF DESCRIPTION OF THE DRAWINGS

FIG. 1 is a rear perspective view of a pump, drive system, and motor.

FIG. 2A is an exploded perspective view of the pump, drive system, and drive of FIG. 1.

FIG. 2B is a cross-sectional view, taken along line 2-2 in FIG. 1.

FIG. 3 is a cross-sectional view of a second pump.

FIG. 4 is a cross-sectional view of a third pump.

FIG. 5 is a cross-sectional view of a piston and pulls.

FIG. 6 is a cross-sectional view taken along line 2-2 in FIG. 1.

FIG. 7 is a cross-sectional view of a fourth pump.

FIG. 8 is a cross-sectional view of a fifth pump.

### DETAILED DESCRIPTION

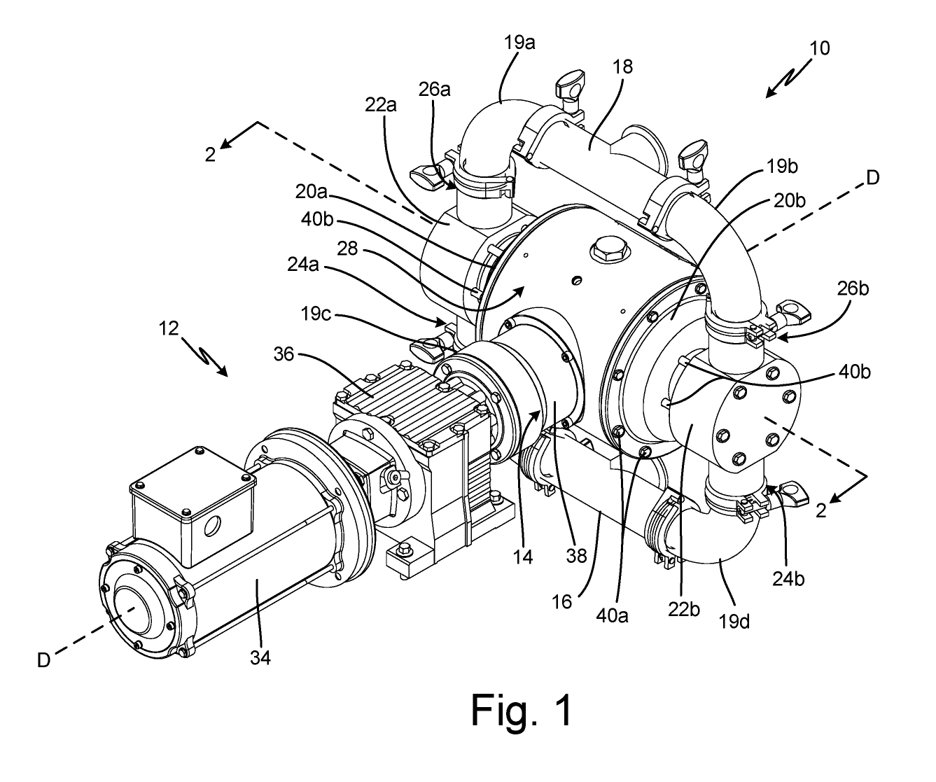

FIG. 1 shows a perspective view of pump 10, electric drive 12, and drive system 14. Pump 10 includes inlet manifold 16; outlet manifold 18; fluid covers 20a, 20b; end covers 22a, 22b; inlet check valves 24a, 24b; and outlet check valves 26a, 26b. Drive system 14 includes housing 28 and piston guide 30. Housing 28 includes working fluid inlet 32. Electric drive 12 includes motor 34, gear reduction 36, and drive 38. Outlet manifold 18 includes elbows 19a, 19b. Inlet manifold 16 includes elbows 19c, 19d.

Housing 28 defines an internal drive chamber that at least partially accommodates drive 38 of electric drive 12. Fluid covers 20a and 20b are attached to housing 28 by fasteners 40a. End covers 22a, 22b are attached, respectively, to fluid covers 20a, 20b by fasteners 40b extending through end covers 22a, 22b into fluid covers 20a, 20b. Fasteners 40a and fasteners 40b can be any desired fastener suitable for connecting various components together for operation. For example, fasteners 40a and fasteners 40b can each be threaded bolts, but it is understood that any other desired type of fastener can be utilized. Elbows 19a, 19b provide a flowpath between outlet manifold 18 and end covers 22a, 22b, respectively. Elbows 19c, 19d, respectively, provide flowpaths between inlet manifold 16 and end covers 22a, 22b. While outlet manifold 18 is described as including elbows 19a, 19b and inlet manifold 16 is described as including elbows 19c, 19d, it is understood that outlet manifold 18 and inlet manifold 16 can include any suitable structure for providing flowpaths into and out of end covers 22a, 22b. It is further understood, that elbows 19a, 19b and elbows 19c, 19d can be separate from or integrated into outlet manifold 18 and inlet manifold 16, respectively.

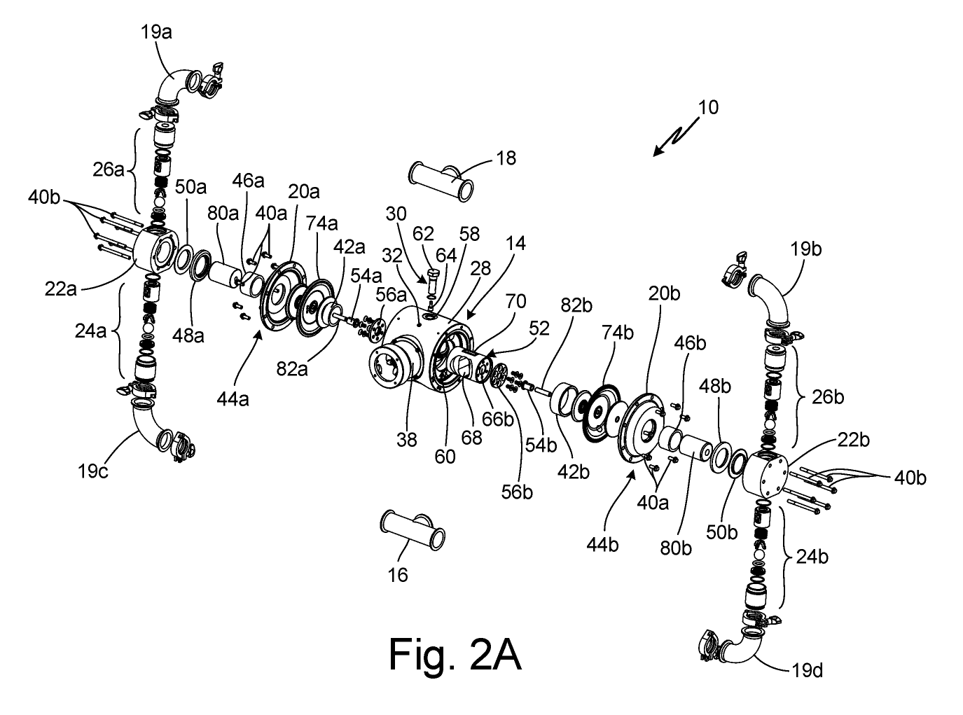

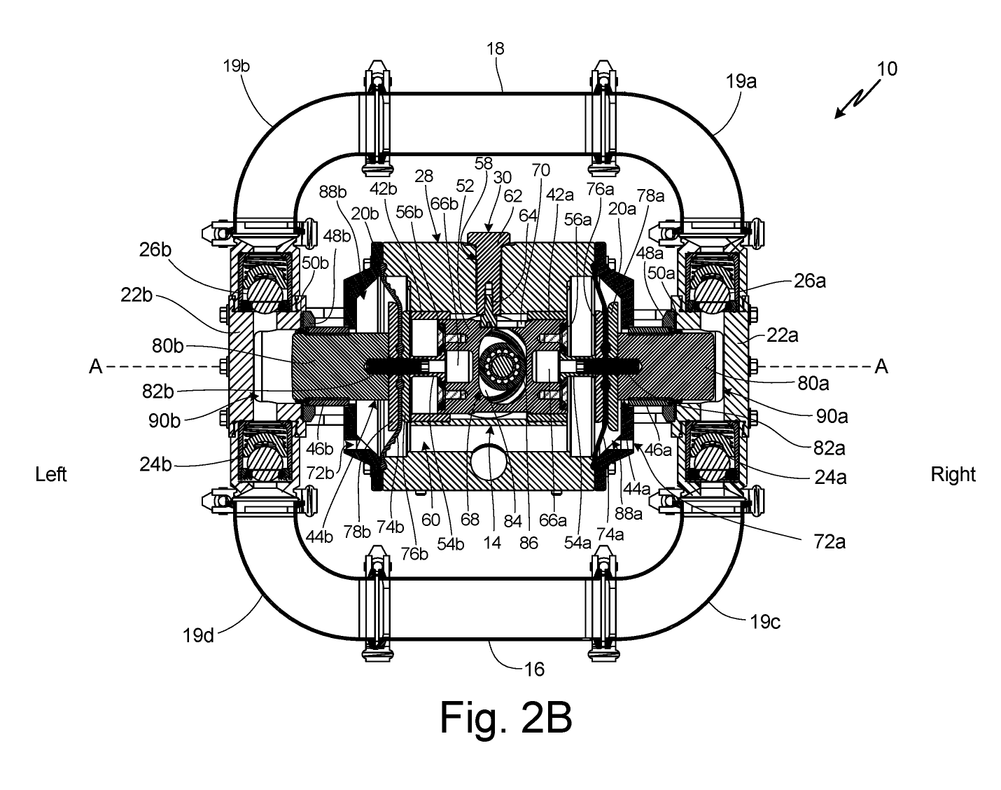

Inlet check valves 24a, 24b (shown in FIG. 2) are disposed between inlet manifold 16 and end covers 22a, 22b, respectively. Outlet check valves 26a, 26b are disposed between outlet manifold 18 and end covers 22a, 22b, respectively. Inlet check valves 24a, 24b, and outlet check valves 26a, 26b are oriented to manage the flow of process fluid from inlet manifold 16 to outlet manifold 18. Inlet check valves 24a, 24b, and outlet check valves 26a, 26b prevent retrograde flow of process fluid from outlet manifold 18 to inlet manifold 16.

Motor 34 is attached to and drives gear reduction drive 38. Gear reduction drive 38 includes internal gearing (not shown) configured to reduce the output speed of motor 34 to a desired driving speed for drive 38. Gear reduction drive 38 powers drive 38 to cause the pumping of pump 10. Drive 38 is secured to housing 28 and extends at least partially into a drive chamber defined by housing 28.

Housing 26 is filled with a working fluid, either a gas, such as compressed air, or a non-compressible hydraulic fluid, through working fluid inlet 30. When the working fluid is a non-compressible hydraulic fluid, housing 26 may further include an accumulator (not shown) for storing a portion of the non-compressible hydraulic fluid during an overpressurization event.

As explained in more detail below, drive 38 causes drive system 14 to draw process fluid from inlet manifold 16 into either of the two flowpaths through end covers 22a, 22b. The working fluid in housing 26 causes a fluid displacement member internal to pump 10 to discharge the process fluid from either flowpath though end covers 22a, 22b to outlet manifold 18. Inlet check valves 24a, 24b prevent the process fluid from backflowing into inlet manifold 16 while the process fluid is being discharged to outlet manifold 18. Similarly, outlet check valves 26a, 26b prevent the process fluid from backflowing into either flowpath from outlet manifold 18 as the process fluid is drawn into the flowpaths from inlet manifold 16.

FIG. 2A is an exploded, perspective view of pump 10. FIG. 2B is a cross-sectional view of pump 10 taken along line 2-2 in FIG. 1. FIGS. 2A and 2B will be discussed together. Pump 10 includes inlet manifold 16; outlet manifold 18; fluid covers 20a, 20b; end covers 22a, 22b; inlet check valves 24a, 24b; outlet check valves 26a, 26b; bushings 42a, 42b; fluid displacement components 44a, 44b; outer cylinders 46a, 46b; collars 48a, 48b; and sealing rings 50a, 50b. Drive system 14 includes housing 28; piston guide 30; piston 52; pulls 54a, 54b; and face plates 56a, 56b. Housing 28 includes working fluid inlet 32 and guide opening 58. Housing 28 defines internal pressure chamber 60. Piston guide 30 includes barrel nut 62 and guide pin 64. Piston 52 includes pull chambers 66a, 66b; central slot 68; and axial slot 70. Fluid covers 20a, 20b include, respectively, ports 72a, 72b. Fluid displacement components 44a, 44b include, respectively, diaphragms 74a, 74b; inner plates 76a, 76b; outer plates 78a, 78b; plungers 80a, 80b; attachment members 82a, 82b. Outlet manifold 18 includes elbows 19a, 19b. Inlet manifold 16 includes elbows 19c, 19d. Drive 38 of electric drive 12 (FIG. 1) is shown. As shown in FIG. 2B, drive 38 includes drive shaft 84 and cam follower 86.

A left-right directional convention is indicated on FIG. 2B. “Inner” as used herein refers to being closer to the axis of drive shaft 84 and/or cam follower 86 while “outer” as used herein refers to being further away from the axis of drive shaft 84 and/or the follower 86 along pump axis A-A in either the left or right direction.

Housing 28 is disposed between fluid cover 20a and fluid cover 20b. Outer cylinder 46a extends between and is retained between fluid cover 20a and end cover 22a. Outer cylinder 46b extends between and is retained between fluid cover 20b and end cover 22b. Inlet manifold 16 is configured to provide process fluid to pumping chambers 90a, 90b (FIG. 2B) within end covers 22a, 22b. Elbow 19c extends to end cover 22a, and elbow 19d extends to end cover 22b. Inlet check valve 24a is disposed between end cover 22a and elbow 19c. Inlet check valve 24b is disposed between end cover 22b and elbow 19d. Inlet check valves 24a, 24b allow the process fluid to flow into end covers 22a, 22b, while preventing the process fluid from backflowing out of end covers 22a, 22b to inlet manifold 16. While inlet check valves 24a, 24b are shown as ball and seat-type check valves, it is understood that any suitable valve for preventing backflow of the process fluid can be utilized.

Outlet manifold 18 is configured to receive process fluid from pumping chambers 90a, 90b. Elbow 19a extends from end cover 22a, and elbow 19b extends from end cover 22b. Outlet check valve 26a is disposed between end cover 22a and elbow 19a. Outlet check valve 26b is disposed between end cover 22b and elbow 19b. Outlet check valves 26a, 26b allow the process fluid to flow out of end covers 22a, 22b, while preventing the process fluid from backflowing into end covers 22a, 22b from outlet manifold 18. While outlet check valves 26a, 26b are shown as ball and seat-type check valves, it is understood that any suitable valve for preventing backflow of the process fluid can be utilized.

Piston 52 is disposed within housing 28 and is configured to be driven in a reciprocating manner along pump axis A-A by drive 38. Drive shaft 84 is powered by electric drive 12 (FIG. 1). Cam follower 86 extends from drive shaft 84 into central slot 68 of piston 52 to drive the reciprocation of piston 52. Cam follower 86 engages the walls defining central slot 68 of piston 52. Bushings 42a, 42b are disposed within and supported by housing 28. Piston 52 is disposed within, and rides on, bushings 42a, 42b, which restrict piston 52 to lateral (left and right) motion. As shown, cam follower 86 is offset from the axial center of the drive shaft 84 such that cam follower 86 orbits the axis of drive shaft 84, instead of merely rotating about its own axis. Due to cam follower 86 being located within vertically orientated central slot 68 of piston 52, cam follower 86 does not push piston 52 up or down. Instead, cam follower 86 forces piston 52 to reciprocate laterally left and right along pump axis A-A. While pump 10 is described as including piston 52, it is understood that any desired type of reciprocating member can be utilized, which may include, but is not limited to, a scotch yoke or other reciprocating drive.

Piston guide 30 extends through housing 28 and is configured to prevent piston 52 from rotating about piston axis A-A. Barrel nut 62 extends through guide opening 58, and guide pin 64 is connected to barrel nut 62. As shown, guide pin 64 rides within axial slot 70 of piston 52 to prevent piston 52 from rotating about piston axis A-A. Piston guide 28 thereby ensures that the motion of piston 52 is limited to reciprocation along piston axis A-A.

Piston 52 includes pull chamber 66a disposed within a first end of piston 52 and pull chamber 66b disposed within a second, opposite end of piston 52. Face plates 56a, 56b are disposed at opposite ends of piston 52 and cap pull chambers 66a, 66b. Face plates 56a, 56b are configured to retain pulls 54a, 54b, within pull chambers 66a, 66b of piston 52. Face plates 56a, 56b include fastener openings to facilitate connection with piston 52. Any desired fastener, such as a bolt, can extend through the fastener openings into piston 52 to secure face plates 56a, 56b to piston 52. Pulls 54a, 54b extend out of pull chambers 66a, 66b through the openings in face plates 56a, 56b.

Pump 10 includes fluid displacement components 44a, 44b. In the present embodiment, fluid displacement components 44a, 44b are shown to include diaphragms 74a, 74b, respectively. It is understood, however, that fluid displacement components 44a, 44b can omit diaphragms or other illustrated components. Fluid displacement components 44a, 44b can be or contain pistons or any other suitable component for displacing process fluid. Additionally, while pump 10 is described as a double displacement pump, utilizing dual fluid displacement components 44a, 44b, it is understood that a single fluid displacement component may be used in a pump (e.g., with only one diaphragm or piston). As such, various examples of pump 10 can be single-displacement or double-displacement pumps.

Fluid covers 20a, 20b are secured to opposite ends of housing 28 by fasteners 40a extending through fluid covers 20a, 20b into housing 28. Ports 72a, 72b extend through fluid covers and fluidly connect outer chambers 88a, 88b, which are defined by diaphragms 74a, 74b and fluid covers 20a, 20b, with the atmosphere. Diaphragm 74a is secured between housing 28 and fluid cover 20a to define and seal, in part, internal pressure chamber 60. Similarly, diaphragm 74b is secured between housing 28 and end cover fluid cover 20b to define and seal, in part, internal pressure chamber 60. Diaphragms 74a, 74b are configured to flex and spring back to a nominal shape. For example, diaphragms 74a, 74b can be elastic disks. Diaphragms 74a, 74b are sandwiched between inner plates 76a, 76b and outer plates 78a, 78b. Inner plates 76a, 76b are disposed on a side of diaphragms 74a, 74b facing internal pressure chamber 60. Outer plates 78a, 78b are disposed on a side of diaphragms 74a, 74b facing outer chambers 88a, 88b.

Diaphragm 74a defines, in part, two chambers: internal pressure chamber 60 and outer chamber 88a. Diaphragm 74b also defines, in part, two chambers: internal pressure chamber 60a and outer chamber 88b. Internal pressure chamber 60 is defined by housing 28 and diaphragms 74a, 74b. Outer chambers 88a, 88b are further defined in part by fluid covers 20a, 20b. The volume of outer chambers 88a, 88b changes inversely with a change in the volume of internal pressure chamber 60 due to the movement of the diaphragms 74a, 74b. For example, when diaphragm 74a is pushed rightward the volume in outer chamber 88a becomes smaller. Such change in volume in outer chamber 88a could increase the pressure within the outer chamber 88a, thereby increasing a countervailing force pushing diaphragm 74a leftward against the force generated by the fluid charge in internal pressure chamber 60. Likewise, leftward movement of diaphragm 74a could create a suction or vacuum condition in outer chamber 88a. However, ports 72a, 72b provide vent paths for outer chambers 88a, 88b to prevent overpressure or vacuum conditions from developing in outer chambers 88a, 88b during pumping, which conditions can cause inefficient pumping.

In some examples, outer chambers 88a, 88b can be sealed to prevent fluid from escaping outer chambers 88a, 88b. In such an example, outer chambers 88a, 88b can be charged with a fluid (gas or liquid), the presence of which may prevent process fluid or working fluid from escaping into and through the outer chambers 88a, 88b. The charge fluid in outer chambers 88a, 88b can thereby prevents contamination of the process fluid or working fluid in the event of seal failure.

Plungers 80a, 80b extend from outer plates 78a, 78b, through outer cylinders 46a, 46b, and into pumping chambers 90a, 90b. Diaphragms 74a, 74b are attached to plungers 80a, 80b by attachment members 82a, 82b. Attachment members 82a, 82b can connect diaphragms 74a, 74b and plungers 80a, 80b in any desired manner. For example, attachment members 82a, 82b can threadedly engage the central holes in plungers 80a, 80b and pulls 54a, 54b, sandwiching and securing inner plates 76a, 76b; the central portions of diaphragms 74a, 74b; and outer plates 78a, 78b therebetween. As such, pull 54a, attachment member 82a, diaphragm 74a, inner plate 76a, outer plate 78a, and plunger 80a are attached as an assembly and move together. Similarly, pull 54b, attachment member 82b, diaphragm 74b, inner plate 76b, outer plate 78b, and plunger 80b are attached as an assembly and move together. While attachment members 82a, 82b are used to connect the central portions of diaphragms 74a, 74b with plungers 80a, 80b, it is understood that plungers 80a, 80b can be connected to diaphragms 74a, 74b in any desired manner. For example, outer plates 78a, 78b can be partially or wholly embedded in the material that forms diaphragms 74a, 74b, and plungers 80a, 80b can be connected (e.g., adhered, welded, bolted, or threadedly attached) to outer plates 78a, 78b. In another example, plungers 80a, 80b are at least partially embedded in the material that forms diaphragms 74a, 74b, thereby omitting outer plates 78a, 78b. In another example, plungers 80a, 80b and outer plates 78a, 78b are integrally formed as a single part.

Fasteners 40b extend through end covers 22a, 22b and into fluid covers 20a, 20b, clamping outer cylinders 46a, 46b therebetween. Plungers 80a, 80b extend into pumping chambers 90a, 90b through outer cylinders 46a, 46b. Pumping chambers 90a, 90b are formed between end covers 22a, 22b and plungers 80a, 80b. Plungers 80a, 80b are configured to slide within outer cylinders 46a, 46b and into and out of pumping chambers 90a, 90b. The diameter of the outer circumference of plungers 80a, 80b is slightly less than the diameter of the inner circumference of outer cylinders 46a, 46b. As such, the outer circumferential surface of plungers 80a, 80b interfaces with the inner circumferential surface of outer cylinders 46a, 46b. These surfaces can be dimensioned to move relative to each other but also seal between themselves. Likewise, the inner surfaces of the inside entrances to end covers 22a, 22b are cylindrical and interface with the outer circumferential surface of plungers 80a, 80b to limit or prevent leakage of process fluid past the interface of plungers 80a, 80b and end covers 22a, 22b.

Collars 48a, 48b are disposed adjacent the inner sides of end covers 22a, 22b. Collars 48a, 48b receive an outer end of outer cylinders 46a, 46b. Sealing rings 50a, 50b are disposed between collars 48a, 48b and end covers 22a, 22b. Sealing rings 50a, 50b extend around and interface with an outer edge of plungers 80a, 80b. Sealing rings 50a, 50b seal circumferentially about plungers 80a, 80b to prevent process fluid within pumping chambers 90a, 90b from escaping along the periphery of the plungers 80a, 80b Likewise, sealing rings 50a, 50b can prevent working fluid that has escaped from internal pressure chamber 60 (or from another source) from entering pumping chambers 90a, 90b and contaminating the process fluid. While pump 10 is described as including outer cylinders 46a, 46b and collars 48a, 48b, it is understood that end covers 22a, 22b can directly abut fluid covers 20a, 20b. In such an example, sealing rings 50a, 50b can be retained between fluid covers 20a, 20b and end covers 22a, 22b.

Internal pressure chamber 60 is configured to be charged with a working fluid during operation of pump 10. The working fluid is either a gas, such as compressed air, or a non-compressible hydraulic fluid. The output pressure from pump 10 is set by charging the working fluid in internal pressure chamber 60 to a desired operational pressure. The working fluid is configured to drive each fluid displacement component 44a, 44b through a pumping stroke, where plungers 80a, 80b are driven into pumping chambers 90a, 90b to reduce the volume of pumping chambers 90a, 90b and drive the process fluid downstream out of pumping chambers 90a, 90b to outlet manifold 18. Piston 52 is configured to draw each fluid displacement component 44a, 44b through a suction stroke, where plungers 80a, 80b are pulled out of pumping chambers 90a, 90b to increase the volume of pumping chambers 90a, 90b and draw the process fluid upstream into pumping chambers 90a, 90b from inlet manifold 16.

During operation, drive shaft 84 rotates about its axis and causes orbital movement of cam follower 86 about driveshaft axis D-D (shown in FIG. 1). Cam follower 86 drives the oscillation of piston 52 along piston axis A-A. Pulls 54a, 54b facilitate mechanical pulling of fluid displacement components 44a, 44b during suction strokes, but not pushing on fluid displacement components 44a, 44b during pumping strokes. Pulls 54a, 54b and piston 52 are configured such that pulls 54a, 54b are unable to exert sufficient pressure on fluid displacement components 44a, 44b to cause fluid displacement components 44a, 44b to proceed through a pumping stroke. While pump 10 is shown as including pulls 54a, 54b, it is understood that any desired intermediate component capable of pulling in tension but not pushing in compression can connect piston 52 to fluid displacement components 44a, 44b.

Pulls 54a, 54b are slidably disposed within pull chambers 66a, 66b. Each pull 54a, 54b has a main body that extends through the pull opening in face plate 56a, 56b. The respective ends of pulls 54a, 54b disposed within pull chambers 66a, 66b are flanged, such that the flanged end of each pull 54a, 54b has a wider diameter than the main body portion of each pull 54a, 54b. While the diameters of pulls 54a, 54b along the main bodies are small enough to slide through the central openings of face plates 56a, 56b, the diameter of the flanged ends of pulls 54a, 54b are too large to fit through the central openings of face plates 56a, 56b.

Face plates 56a, 56b are configured to engage the flanged ends of pulls 54a, 54b to facilitate the suction stoke of each fluid displacement components 44a, 44b. Piston 52 is thereby capable of pulling pulls 54a, 54b, and thus fluid displacement components 44a, 44b, inward through a suction stroke, but is incapable of pushing fluid displacement components 44a, 44b outward through a pumping stroke. Pull chambers 66a, 66b are dimensioned such that pulls 54a, 54b simply slide further into pull chambers 66a, 66b as piston 52 moves toward fluid displacement components 44a, 44b.

Piston 52 is driven leftward and rightward along piston axis A-A by cam follower 86. As piston 52 moves leftward, piston 52 pulls, by way of face plate 56a, pull 54a to the left. Piston 52 thereby pulls fluid displacement component 44a to the left due to the connection of pull 54a and fluid displacement component 44a. However, the flanged end of pull 54a can move within pull chamber 66a, so when piston 52 reaches the end of the leftward travel and reverses to rightward travel, the flanged end of pull 54a can slide relative to piston 52 within pull chamber 66a. As such, piston 52 is prevented from pushing on pull 54a as piston 52 moves rightward. Piston 52 thereby does not drive fluid displacement component 44a rightward through a pumping stroke. Instead, what moves fluid displacement component 44a rightward is the charge pressure of the working fluid within internal pressure chamber 60 pushing on the inner side of the fluid displacement component 44a, and specifically on inner plate 76a and the diaphragm 74a.

Inward movement, to the left, of fluid displacement component 44a, due to the connection of fluid displacement component 44a with piston 52 via pull 54a and face plate 56a, partially withdraws the outer end of plunger 80a from pumping chamber 90a within end cover 22a. Such movement increases the available volume within the pumping chamber 90a, creating a suction condition that opens inlet check valve 24a and draws the process fluid from inlet manifold 16 into pumping chamber 90a past inlet check valve 24a. The suction condition also causes outlet check valve 26a to close, thereby preventing retrograde flow of process fluid from outlet manifold 18 into pumping chamber 90a.

As piston 52 travels leftward the charge pressure of the working fluid within internal pressure chamber 60 drives fluid displacement component 44b leftward through a pumping stroke. Piston 52 does not mechanically force fluid displacement component 44b to move leftward (outward) because the inner flanged end of pull 54b slides within pull chamber 66b, preventing piston 52 from pushing on pull 54b. Instead, the charge pressure of the working fluid in internal pressure chamber 60 pushes fluid displacement component 44b, and specifically diaphragm 74b and inner plate 76b, thereby forcing plunger 80b further into pumping chamber 90b. Forcing plunger 80b into pumping chamber 90b reduces the available volume within pumping chamber 90b, increasing the pressure within pumping chamber 90b. The increased pressure causes outlet check valve 26b to open and drives the process fluid downstream out of pumping chamber 90b through outlet check valve 26b. The process fluid flows out of pumping chamber 90b into outlet manifold 18. The increased pressure in pumping chamber 90b due to the advancement of plunger 80b also causes inlet check valve 24b to close, thereby preventing retrograde flow of process fluid from pumping chamber 90b upstream past inlet check valve 24b.

After piston 52 reaches the furthest extent of its leftward movement, piston 52 reverses course and is driven rightward by cam follower 86. As discussed above, the charge pressure of the working fluid drives fluid displacement component 44a through a pumping stroke as piston 52 moves rightward, and piston 52 pulls fluid displacement component 44b through a suction stroke as piston 52 moves rightward.

As piston 52 moves rightward, piston 52 pulls pull 54b, by way of face plate 56b, to the right. Piston 52 thereby pulls fluid displacement component 44b to the right, causing fluid displacement component 44b to proceed through a suction stroke. However, the flanged end of pull 54b can move within pull chamber 66b. As such, when piston 52 reaches the end of its rightward travel and reverses to leftward travel, the flanged end of pull 54b can slide relative to piston 52 within pull chamber 66b, and piston 52 is prevented from pushing on pull 54b as piston 52 moves leftward. Piston 52 thereby does not drive fluid displacement component 44b leftward through a pumping stroke. Instead, the charge pressure within internal pressure chamber 60 pushing on the inner side of the fluid displacement component 44b, and specifically on inner plate 76b and the diaphragm 74b, moves fluid displacement component 44b leftward through a pumping stroke.

Inward movement, to the right, of fluid displacement component 44b, due to the connection of fluid displacement component 44b and piston 52 via pull 54b and face plate 56b, partially withdraws the outer end of plunger 80b from pumping chamber 90b within end cover 22b. Such movement increases the available volume within the pumping chamber 90b, creating a suction condition that opens inlet check valve 24b and draws the process fluid from inlet manifold 16 into pumping chamber 90b past inlet check valve 24b. The suction condition also causes outlet check valve 26b to close, thereby preventing retrograde flow of process fluid from outlet manifold 18 into pumping chamber 90b.

As piston 52 travels rightward the charge pressure of the working fluid within internal pressure chamber 60 drives fluid displacement component 44a rightward through a pumping stroke. Piston 52 does not mechanically force fluid displacement component 44a to move rightward (outward) because the inner flange end of pull 84a slides within pull chamber 66a. Instead, it is the charge pressure of the working fluid in internal pressure chamber 60 that pushes fluid displacement component 44a, and specifically diaphragm 74a and inner plate 76a, forcing plunger 80a further into pumping chamber 90a. Forcing plunger 80a into pumping chamber 90a reduces the available volume within pumping chamber 90a, increasing the pressure within pumping chamber 90a, thereby causing outlet check valve 26a to open and driving the process fluid downstream out of pumping chamber 90a through outlet check valve 26. The process fluid flows out of pumping chamber 90a into outlet manifold 18. The increased pressure in pumping chamber 90a due to the advancement of plunger 80a causes inlet check valve 24a to close, thereby preventing retrograde flow of process fluid from pumping chamber 90a upstream past inlet check valve 24a.

Fluid displacement components 44a, 44b are thereby mechanically pulled through their respective suction strokes, but are not mechanically pushed during their respective pumping strokes. Instead, the charge pressure of the working fluid within internal pressure chamber pushes, either pneumatically or hydraulically, on the inner side of fluid displacement components 44a, 44b to drive fluid displacement components 44a, 44b through their respective pumping strokes.

Pump 10 and the alternating use of piston 52 to mechanically pull, but not mechanically push, the fluid displacement components 44a, 44b during the suction stroke, and use of a charge of pressurized fluid within internal pressure chamber 60 to pneumatically or hydraulically push, but not pull, fluid displacement components 44a, 44b during the pumping stroke provides significant advantages. Piston 52 is prevented from exerting an uncompromising mechanical pushing force on either fluid displacement component 44a, 44b, which would otherwise risk dramatically spiking the pressure within the process fluid, particularly when an outlet for the process fluid is suddenly shutoff or otherwise blocked (known as a deadhead condition). In some embodiments of the present disclosure, all of the pressure placed on the process fluid by pump 10 is generated by the charge of the pressurized working fluid within internal pressure chamber 60.

If the pressure in the process fluid exceeds the pressure in the working fluid, then fluid displacement components 44a, 44b will not be pushed through a pumping stroke, thus avoiding a spike in process fluid pressure. In the deadhead condition, drive 38 will continue to drive the oscillation of piston 52, but pulls 54a, 54b and fluid displacement components 44a, 44b will remain in a retracted (suction stroke) position over one or multiple reciprocation cycles of piston 52. Fluid displacement components 44a, 44b remain in the retracted position because the working fluid pressure is insufficient to push fluid displacement components 44a, 44b, through a pumping stroke. One or both of fluid displacement components 44a, 44b, will be remain in the retracted position until the downstream pressure of the process fluid decreases to a level below the working fluid pressure, such that the working fluid pressure can cause fluid displacement components 44a, 44b to enter their respective pumping strokes. Allowing piston 52 to continue to oscillate without pushing either fluid displacement component 44a, 44b into a pumping stroke allows pump 10 to continue to run during the deadhead condition without causing any harm to the motor or pump. As piston 54 continues to oscillate, pulls 54a, 54b will simply slide within pull chambers 66a, 66b without imparting the pushing force to fluid displacement components 44a, 44b necessary to initiate the pumping stroke. Allowing pump 10 to continue to run prevents undesired wear to components of pump 10 that can occur due to repeated start up and shut down. In addition, allowing pump 10 to continue to run increases the efficiency of the pumping operation, as the user is not required to stop and start pump 10 whenever the user desired to close the outlet. Moreover, damage to various components of pump 10 is avoided, as electric drive 12 (FIG. 1) and drive 14 will not experience unexpected resistance during the deadhead, as pulls 54a, 54b simply slide within pull chambers 66a, 66b instead of transmitting forces to piston 52 from fluid displacement members 44a, 44b.

Another benefit, in some embodiments, is a reduction or elimination of downstream pulsation of the process fluid. A constant downstream pressure can be produced by pump 10 to eliminate pulsation by sequencing the speed of piston 52 with the pumping stroke caused by the working fluid. Sequencing the suction and pumping strokes can prevent drive system 14 from entering a state of rest where one fluid displacement member 44a, 44b completes a pumping stroke prior to piston 52 reversing course along pump axis A-A.

Piston 52 is sequenced by setting the speed of oscillation and/or the pressure of the working fluid such that when piston 52 begins to pull one fluid displacement component 44a, 44b into a suction stroke prior to that fluid displacement component 44a, 44b completing a pumping stroke. This is possible because piston 52 can pull one fluid displacement component 44a, 44b through a suction stroke faster than the working fluid charge pressure can drive the other fluid displacement component 44a, 44b through an entire pumping stroke. The difference in speed can be achieved due to the different causes of pulling (mechanical) and pushing (fluid). Therefore, at least one fluid displacement component 44a, 44b is always moving in a pumping stroke, which eliminates pulsation because process fluid is constantly discharged to outlet manifold 18 at a constant rate.

Moreover, pump 10 can generate higher output pressures in the process fluid than the charge pressure of the working fluid. The respective surface areas of fluid displacement components 44a, 44b on which the working fluid directly contacts and pushes are larger than the respective surface areas of fluid displacement components 44a, 44b that directly contact and push on the process fluid.

More specific to the illustrated embodiment, the diameter of the inner parts of fluid displacement components 44a, 44b that contact and are pushed upon by the working fluid (e.g., defined by diaphragms 74a, 74b and inner plates 76a, 76b) is larger than the diameter of the outer end faces of plungers 80a, 80b that contact and push upon the process fluid. Therefore, while the lateral travel of the working fluid-contacting surface and the process fluid-contacting surface of fluid displacement components 44a, 44b are the same, the displacements of the working fluid and the process fluid will be different for every stroke due to the difference in diameters and overall fluid-contacting surface areas. The displacement of process fluid by the outer ends of plungers 80a, 80b is smaller for each stroke as compared to the displacement of working fluid, but the pressure generated in the process fluid is greater than the pressure of the working fluid acting on fluid displacement components 44a, 44b. This generates higher process fluid pressure within pumping chambers 90a, 90b. The process fluid pressure is higher even than the working fluid pressure in internal pressure chamber 60. Therefore, the pumping pressure developed in pumping chambers 90a, 90b and further downstream due to the pumping strokes of fluid displacement components 44a, 44b can be higher than the working fluid pressure that acts upon and pushes fluid displacement components 44a, 44b. The pressure multiplication provides a more compact pump 10, as pump 10 can provide higher pumping pressures in a more compact arrangement due to the variations in surface area. Moreover, pump 10 has increased efficiency, as less energy is required to charge the working fluid to achieve the desired output pressure.

High pressure output of process fluid is beneficial in various applications of fluid handling, such as for dispensing or spraying viscous fluid. Embodiments of the present disclosure extend the output pressure from pump 10 above the supply pressure while still allowing the downstream outlet of pump 10 to be shutoff or otherwise deadheaded without concern of spiking pressure or damaging pump 10. For example, the user may only have a 100 PSI compressor available for generating the initial charge of working fluid within internal pressure chamber 60. The mechanical advantage gained by fluid displacement components 44a, 44b having different sized working/process fluid contacting surfaces, and therefore different working/process fluid displacements, allows the output pressure of process fluid to be significantly higher than 100 PSI. Moreover, the user's application may further require frequent starting and stopping of process fluid dispenses, which results in frequent deadheading of the fluid. Pulls 54a, 54b avoid pressure spikes and prevent pump 10 from suffering damage that can otherwise result from frequent starting and stopping of process fluid dispenses. Pulls 54a, 54b house within pull chambers 66a, 66b and prevent piston 52 from pushing on fluid displacement components 44a, 44b, while facilitating piston 52 pulling fluid displacement components 44a, 44b.

When compressed air is used as the working fluid, drive system 14 eliminates the possibility of exhaust icing, as can be found in air-driven pumps, because the compressed air in drive system 14 is not exhausted after each stroke. Other exhaust problems are also eliminated, such as safety hazards that arise from exhaust becoming contaminated with process fluids. Additionally, higher energy efficiency can be achieved with drive system 14 because internal pressure chamber 60 eliminates the need to provide a fresh dose of compressed air during each stroke, as is found in typical air operated pumps. When a non-compressible hydraulic fluid is used as the working fluid, drive system 14 eliminates the need for complex hydraulic circuits with multiple compartments, as can be found in typical hydraulically driven pumps. Additionally, drive system 14 eliminates the contamination risk between the process fluid and the working fluid due to the balanced forces on either side of fluid displacement components 44a, 44b.

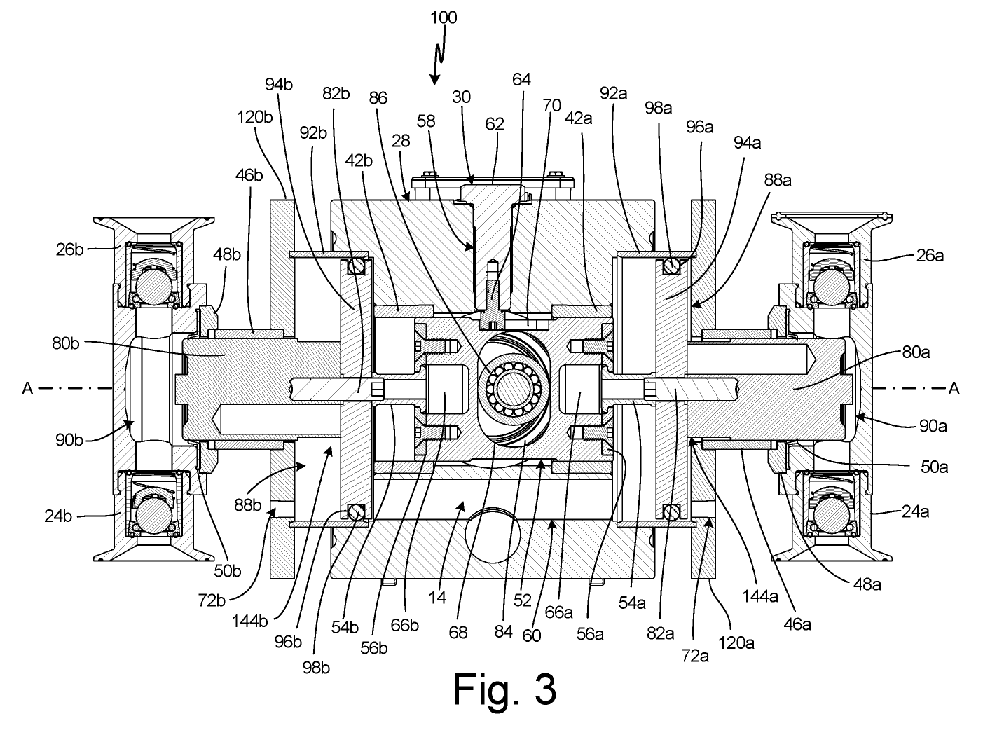

FIG. 3 is a cross-sectional view of pump 100. Pump 100 includes end covers 22a, 22b; inlet check valves 24a, 24b; outlet check valves 26a, 26b; bushings 42a, 42b; outer cylinders 46a, 46b; collars 48a, 48b; sealing rings 50a, 50b; drive cylinders 92a, 92b; fluid covers 120a, 120b; and fluid displacement components 144a, 144b. Drive system 14 includes housing 28; piston guide 30; piston 52; pulls 54a, 54b; and face plates 56a, 56b. Housing 28 includes guide opening 58 and defines internal pressure chamber 60. Piston guide 30 includes barrel nut 62 and guide pin 64. Piston 52 includes pull chambers 66a, 66b; central slot 68; and axial slot 70. Fluid covers 120a, 120b include, respectively, ports 72a, 72b. Fluid displacement components 144a, 144b include, respectively, plungers 80a, 80b; attachment members 82a, 82b; and drive pistons 94a, 94b. Drive pistons 94a, 94b include piston grooves 96a, 96b and piston rings 98a, 98b. Outlet manifold 18 includes elbows 19a, 19b. Inlet manifold 16 includes elbows 19c, 19d. Drive shaft 84 and cam follower 86 of drive 38 are shown.

Housing 28 defines internal pressure chamber 60. Bushings 42a, 42b are disposed within housing. Piston 52 is disposed within housing 28 and supported by bushings 42a, 42b. Cam follower 86 extends into central slot 68 of piston 52 and is configured to drive oscillation of piston 52 along piston axis A-A. Piston guide 30 extends through housing 28 and engages axial slot 70 of piston 52 to prevent piston 52 from rotating about piston axis A-A. Barrel nut 68 extends through guide opening 60, and guide pin 70 is connected to barrel nut 68. As shown, guide pin 70 rides within axial slot 76 of piston 52 to prevent piston 52 from rotating about piston axis A-A.

Piston 52 includes pull chamber 72a disposed within a first end of piston 52 and pull chamber 72b disposed within a second, opposite end of piston 52. Face plates 56a, 56b are disposed at opposite ends of piston 52 and cap pull chambers 66a, 66b. Face plates 56a, 56b are configured to retain pulls 54a, 54b, within pull chambers 66a, 66b of piston 52. Face plates 56a, 56b include fastener openings to facilitate connection with piston 52. Any desired fastener, such as a bolt, can extend through the fastener openings into piston 52 to secure face plates 56a, 56b to piston 52. Pulls 86a, 86b extend out of pull chambers 72a, 72b through openings in face plates 56a, 56b.

Drive cylinders 92a, 92b are disposed between housing 28 and fluid covers 120a, 120b. Fluid covers 120a, 120b are attached to housing 28 by fasteners (not shown) extending through fluid covers 120a, 120b into housing 28. Outer cylinders 46a, 46b are disposed between fluid covers 120a, 120b and end covers 22a, 22b. End covers 22a, 22b are attached to fluid covers 120a, 120b by fasteners (not shown) extending through end covers 22a, 22b into fluid covers 120a, 120b. Collars 48a, 48b are disposed adjacent the inner sides of end covers 22a, 22b. Collars 48a, 48b receive an outer end of outer cylinders 46a, 46b. Sealing rings 50a, 50b are disposed between collars 48a, 48b and end covers 22a, 22b. Sealing rings 50a, 50b extend around and interface with an outer edge of plungers 80a, 80b.

Fluid displacement components 144a, 144b are configured to draw process fluid into pumping chambers 90a, 90b during suction strokes and to drive process fluid downstream out of pumping chambers 90a, 90b during pumping strokes. Drive pistons 94a, 94b are disposed within drive cylinders 92a, 92b. Drive piston 94a defines, in part, two chambers: internal pressure chamber 60 and outer chamber 88a. Drive piston 94b similarly defines, in part, two chambers: internal pressure chamber and outer chamber 88b. Internal pressure chamber 60 is defined by housing 28 and drive pistons 94a, 94b. Outer chambers 88a, 88b are further defined in part by fluid covers 120a, 120b. The volume of outer chambers 88a, 88b changes inversely with a change in the volume of internal pressure chamber 60 due to the movement of the drive pistons 94a, 94b. Ports 72a, 72b extend through fluid covers 120a, 120b, respectively, to connect outer chambers 88a, 88b to the atmosphere and prevent overpressurization and/or vacuum conditions from forming in outer chambers 88a, 88b.

Piston grooves 96a, 96b extend circumferentially about drive pistons 94a, 94b. Piston rings 98a, 98b are disposed in piston grooves 96a, 96b and are configured to interface with and seal against an inner circumferential surface of drive cylinders 92a, 92b. Piston rings 98a, 98b fluidly isolate internal pressure chamber 60 from outer chambers 88a, 88b. Piston rings 98a, 98b form a dynamic seal with the inner surface of drive cylinders 92a, 92b as drive pistons 94a, 94b oscillate within drive cylinders 92a, 92b during operation.

Plungers 80a, 80b extend from drive pistons 94a, 94b and into pumping chambers 90a, 90b. Plungers 80a, 80b extend through outer cylinders 46a, 46b. Pull 54a, drive piston 94a, and plunger 80a are connected to move as an assembly. Similarly, pull 54b, drive piston 94b, and plunger 80b are connected to move as an assembly. Attachment members 82a, 82b extend through drive pistons 94a, 94b and into pulls 54a, 54b and plungers 80a, 80b. In some examples, the openings in each of pulls 54a, 54b; drive pistons 94a, 94b; and plungers 80a, 80b are threaded to engage with threaded attachment members 82a, 82b. It is understood, however, that pulls 54a, 54b; drive pistons 94a, 94b; and plungers 80a, 80b can be interconnected in any desired manner. In one example, drive pistons 94a, 94b and plungers 80a, 80b are integrally formed as a single component. As such, fluid displacement components 144a, 144b can be single-piece, dual-diameter pistons.

The operation of pump 100′ is similar to the operation of pump 100 (FIGS. 2A-2B), except the working fluid acts on drive pistons 94a, 94b instead of diaphragms 74a, 74b (FIGS. 2A-2B). As piston 52 is driven rightward by cam follower 86, piston 52 pulls fluid displacement component 144b to the right due to the connection of pull 54b and fluid displacement component 144b. Pulling fluid displacement component 144b to the right retracts plunger 80b from fluid cavity 90b creating suction and drawing the process fluid into fluid cavity 90b through inlet valve 24b.

As piston 52 moves rightward, the charge pressure of the working fluid in internal pressure chamber 60 drives fluid displacement component 144a rightward. The rightward movement of fluid displacement component 144a causes plunger 80a to proceed into fluid cavity 90a, thereby decreasing the volume of fluid cavity 90a and driving the process fluid out of fluid cavity 90a through outlet check valve 26a.

The charge pressure acts on the inner faces of drive piston 94a to cause the rightward movement of fluid displacement component 144a. The diameter D1 of drive piston 94a is larger than the diameter D2 of plunger 80a. As such, the area of drive piston 94a acted on by the working fluid is larger than the area of plunger 80a acting on the process fluid. The force exerted on drive piston 94a by the working fluid is the same as the force exerted on the process fluid by plunger 80a, due to the rigid connection between drive piston 94a and plunger 80a. Because the forces are the same, the pressure differential between the working fluid and the process fluid is the inverse of the area differential between the inner face of drive piston 94a and the outer face of plunger 80a. Force (F) is related to surface area (A) and pressure (P) according to the following equation:

F=PA

As such, assuming that the working fluid has a charge pressure of about 100 psi, that driving piston 94a has a diameter of about 2 in, and that plunger 80a has a diameter of about 1 in. The output pressure of the process fluid generated by fluid displacement component 144a is thus about 400 psi. The diameters D1 and D2 can be dimensioned according to any desired ratio to provide the desired output pressure based on the set charge pressure.

After piston 52 has shifted rightward, cam follower 86 causes piston 52 to reverse direction and move leftward. Face plate 56a engages the flanged end of pull 54a, and piston 52 begins to pull fluid displacement component 144a through a suction stroke. Plunger 80a is withdrawn from pumping chamber 90a, creating suction in pumping chamber 90a and drawing the process fluid into pumping chamber 90a through inlet valve 24a.

As piston 94a pulls fluid displacement component 144a through a suction stroke, the charge pressure of the working fluid pushes fluid displacement component 144a through a pumping stroke. The charge pressure acts on the inner face of drive piston 94b to push fluid displacement component 144b through the pumping stroke. Plunger 80b is driven into pumping chamber 90b by drive piston 94b, thereby decreasing the volume in pumping chamber 90b and driving the process fluid downstream from pumping chamber 90b through outlet valve 26b. Fluid displacement component 144b provides a force multiplication similar to fluid displacement component 144a.

Pump 100 provides significant advantages. The working fluid in internal pressure chamber 60 acts on the inner faces of drive pistons 94a, 94b to drive fluid displacement components 144a, 144b through respective pumping strokes. Drive pistons 94a, 94b reciprocate within drive cylinders 92a, 92b and remain rigid during pumping. Because drive pistons 94a, 94b are rigid, the full area of drive pistons 94a, 94b are able to transmit the full force from the working fluid to plungers 80a, 80b across the full displacement distance of fluid displacement components 144a, 144b. Drive pistons 94a, 94b thereby provide consistent force multiplication to plungers 80a, 80b throughout the displacement of fluid displacement components 144a, 144b. The force multiplication provided by fluid displacement components 144a, 144b provides for a greater pressure output from a more compact pump 100. The more compact pump arrangement is less costly to manufacture, easier for the end user to use and store, and more energy efficient.

In addition, the reciprocation of piston 52 can be sequenced to provide pulseless downstream flow. To achieve the pulseless flow, the speed of piston 52 is set such that piston 52 begins to pull fluid displacement components 144a, 144b into suction strokes prior to that fluid displacement component 144a, 144b completing its pumping stroke. As such, at least one fluid displacement component 144a, 144b is always proceeding through a pumping stroke and providing the process fluid downstream. The process fluid is pumped out of each pumping chamber 90a, 90b and provided to outlet manifold 18 at the same pressure because each fluid displacement component 144a, 144b is driven by the same charge pressure of the working fluid.

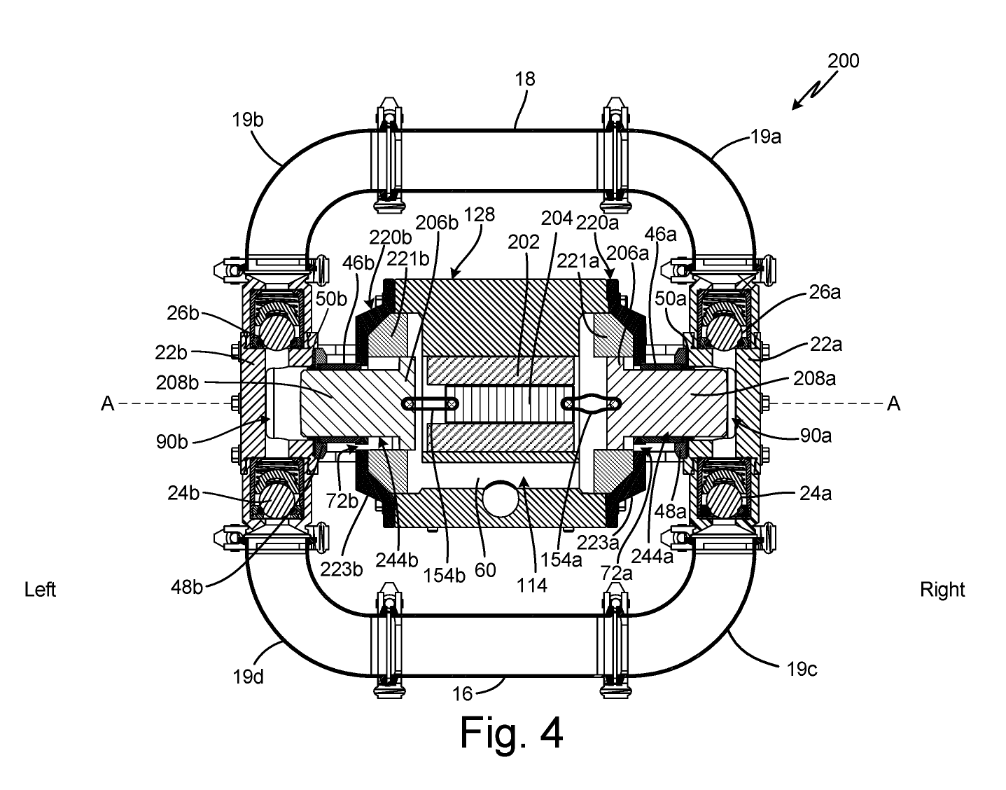

FIG. 4 is a cross-sectional view of pump 200. Pump 200 includes inlet manifold 16; outlet manifold 18; end covers 22a, 22b; inlet check valves 24a, 24b; outlet check valves 26a, 26b; outer cylinders 46a, 46b; collars 48a, 48b; sealing rings 50a, 50b; fluid covers 220a, 220b; and fluid displacement components 244a, 244b. Drive system 114 includes housing 128, solenoid 202, armature 204, and pulls 154a, 154b. Housing 128 defines internal pressure chamber 60. Fluid covers 220a, 220b include, respectively, ports 72a, 72b. Fluid displacement components 244a, 244b include inner portion 206a, 206b and outer portion 208a, 208b. Outlet manifold 18 includes elbows 19a, 19b. Inlet manifold 16 includes elbows 19c, 19d.

Pump 200 is similar to pump 10 (FIGS. 2A-2B) and pump 100 (FIG. 3), except pump 200 is electrically driven. In addition, pulls 154a, 154b are bands instead of shafts having flanged and attachment ends. Housing 28 defines internal pressure chamber 60. Solenoid 202 is supported by housing 28 and is electrically connected to a power source. The power source can be external to pump 10, such motor 34 (FIG. 1) or an electric cord configured to connect to the electric grid, or internal to pump 10, such as a battery mounted in housing 28. However, with solenoid 202 supported by housing 28, drive system 14 can be considered as having the power source of drive system 14 integrated into housing 28 and internal pressure chamber 60.

Armature 204 is disposed within and configured to be driven by solenoid 202. Armature 204 is connected to fluid displacement components 44a, 44b by pulls 154a, 154b. Pulls 154a, 154b are attached to armature 204 and to inner portions 206a, 206b of fluid displacement components 244a, 244b. In the example shown, pulls 154a, 154b include flexible members, such as plastic, rubber, or elastic bands that pull in tension but do not meaningfully push in compression. Instead, in compression, pulls 154a, 154b are configured to bend so as to not transfer a compressive or pushing force to fluid displacement components 244a, 244b. Pulls 154a, 154b can be secured to armature 204 and fluid displacement components 244a, 244b in any desired manner. For example, inner portion 206a, 206b can include a groove and a cross-bore, with the end of the band forming pull 154a, 154b inserted into the groove and a set pin or cotter pin inserted into the cross-bore to retain the end of the band. In another example, pulls 154a, 154b can be integrally molded to one of fluid displacement components 244a, 244b or armature 204. Pulls 154a, 154b can also be attached to armature 204 in any desired manner, such as by pins.

While pump 10 is described as including pulls 154a, 154b, it is understood that armature 204 and fluid displacement components 244a, 244b can be connected in any desired manner. For example, armature 204 can include pull chambers, similar to pull chambers 66a, 66b (FIGS. 2B-3), extending into opposite ends of armature 204. Pulls 54a, 54b (FIGS. 2B-3) can then extend from the pull chambers and be connected to fluid displacement components 244a, 244b in any desired manner, such as by attachment members 82a, 82b (FIGS. 2B-3).

Solenoid 202 and armature 204 are of any suitable configuration for causing armature 204 to reciprocate along pump axis A-A. Solenoid 202 can be either a single-acting solenoid, such that solenoid 202 drives armature 204 in a single direction and a spring drives armature 204 in the other direction, or a double-acting solenoid, such that solenoid 202 drives armature 204 in both the left and right directions. In examples where solenoid 202 is double-acting, armature 204 can be a permanent magnet such that reversing the polarity through solenoid 202 drives the reciprocation of armature 204. In examples where solenoid 202 is single-acting, solenoid 202 can be configured to drive armature 204 in a first direction and a spring (not shown) can be configured to drive armature 204 in a second, opposite direction. For example, solenoid 202 can be configured to pull armature 204 leftward, causing armature 204 to pull fluid displacement component 44a through a suction stroke. The spring can be configured to push armature 204 rightward, causing armature 204 to pull fluid displacement component 44b through a suction stroke. It is understood that solenoid 202 can pull armature 204 rightward and the spring can push armature leftward.

Outer portions 208a, 208b and inner portions 206a, 206b of fluid displacement components 244a, 244b are integrally formed. Outer portions 208a, 208b extends from inner portions 206a, 206b through outer cylinder 46a, 46b and into fluid cavity 90a, 90b. Inner portion 206a, 206b is surrounded by a bore within fluid cover 220a, 220b. Is some examples, fluid covers 220a, 220b are formed from multiple components, such as inner cover portions 221a, 221b and outer cover portions 223a, 223b. In other examples, fluid covers 220a, 220b can be formed from a single part. For example, each fluid cover 220a, 220b can include outer cover portion 223a, 223b that is bolted to the central portion of housing 128, and inner cover portions 221a, 221b that define the bore within which inner portions 206a, 206b of fluid displacement components 244a, 244b reciprocate. Outer cover portions 223a, 223b and inner cover portions 221a, 221b can be formed of different materials. For example, outer cover portions 223a, 223b can be metallic, and inner cover portions 221a, 221b can be formed from a material suitable for sealing directly or indirectly with inner portions 206a, 206b. In one example, inner cover portions 221a, 221b of each fluid cover 220a, 220b can be formed from an elastomer. In another example, inner portions 206a, 206b can each include a circumferential groove and a seal (similar to grooves 96a, 96b and rings 98a, 98b shown in FIG. 3), and the seal can seal against inner cover portions 221a, 221b of each fluid cover 220a, 220b.

Inner portion 206a defines, in part, two chambers: internal pressure chamber 60 and outer chamber 88a. Inner portion 206b defines, in part, two chambers: internal pressure chamber 60 and outer chamber 88b. Internal pressure chamber 60 is defined by housing 28 and inner portions 206a, 206b. Outer chambers 88a, 88b are further defined in part by fluid covers 220a, 220b. Inner portions 206a, 206b seal against the bores in fluid covers 220a, 220b to prevent the working fluid from leaking out of internal pressure chamber 60 into outer chambers 88a, 88b. Ports 72a, 72b provide vent path between outer chambers 88a, 88b and the atmosphere.

The operation of pump 200 is similar to the operation of pump 10 (FIGS. 2A-2B) and pump 100 (FIG. 3), except the working fluid acts on fluid displacement components 244a, 244b and reciprocation is caused by solenoid 202 and armature 204. A charge is provided to solenoid 202 to cause displacement of armature 204 along pump axis A-A. As armature 204 moves rightward, armature 204 pulls fluid displacement component 244b to the right due to pull 154b connecting armature 204 and fluid displacement component 244b. Pulling fluid displacement component 44b retracts outer portion 208b from pumping cavity 90b, creating suction and drawing the process fluid into pumping cavity 90b through inlet valve 24b.

As armature 204 moves rightward, the charge pressure of the working fluid in internal pressure chamber 60 drives fluid displacement component 244a rightward. The rightward movement of fluid displacement component 244a causes outer portion 208a to move into pumping cavity 90a, thereby decreasing the volume of pumping cavity 90a and driving the process fluid out of pumping cavity 90a through outlet check valve 26a. The working fluid acts on inner portion 206a to drive fluid displacement component 244a. In the example shown, inner portion 206a has a larger diameter than outer portion 208a, and as such fluid displacement component 244a provides a force multiplication between the charge pressure of the working fluid and the output pressure of the process fluid.

After armature 204 has shifted rightward, armature 204 reverses direction and moves leftward. As discussed above, the leftward movement can be caused by a spring when the charge is removed from solenoid 202, by a reversal of the polarity of the charge to solenoid 202, or by any other suitable mechanism or method. Pull 154a connects armature 204 and fluid displacement component 44a, and pull 154a pulls fluid displacement component 44a through a suction stroke. Outer portion 208a is withdrawn from pumping chamber 90a, creating suction in pumping chamber 90a and drawing the process fluid into pumping chamber 90a through inlet valve 24a.

As armature 204a pulls fluid displacement component 44a through a suction stroke, the charge pressure of the working fluid pushes fluid displacement component 44b through a pumping stroke. The charge pressure acts on inner portion 206b to push fluid displacement component 44b through the pumping stroke. Outer portion 208b is driven into pumping chamber 90b by inner portion 206b, thereby decreasing the volume in pumping chamber 90b and driving the process fluid downstream from pumping chamber 90b through outlet valve 26b. Fluid displacement component 244b provides a force multiplication similar to fluid displacement component 244a.

Pump 200 provides significant advantages. The electric driving components, solenoid 202 and armature 204, are disposed within housing 28 and internal pressure chamber 60, which provides for a compact, self-contained pump. Fluid displacement components 244a, 244b provide force multiplication between the charge pressure within internal pressure chamber 60 and the output pressure of the process fluid due to the differing diameters of inner portions 206a, 206b and outer portions 208a, 208b. Armature 204 pulls fluid displacement components 244a, 244b through suction strokes but is prevented from pushing fluid displacement components 244a, 244b through pumping strokes by pulls 154a, 154b. Instead, the working fluid pushes fluid displacement components 244a, 244b through the pumping strokes. As such, the strokes of fluid displacement components 244a, 244b can be sequenced to eliminate downstream pulsation. In addition, pump 10 can be deadheaded without damaging any components, as pulls 154a, 154b do not transfer compressive, pumping forces to fluid displacement components 244a, 244b.

As shown, different drive mechanisms, reciprocating members, pulls, and fluid displacement components are possible, and embodiments consistent with this disclosure are not limited to the particular embodiments or options disclosed herein. While electrically driven motors and pistons have been disclosed herein, an air or hydraulically driven piston or other reciprocating member could be used instead of or in combination with any fluid displacement component of any embodiment herein.

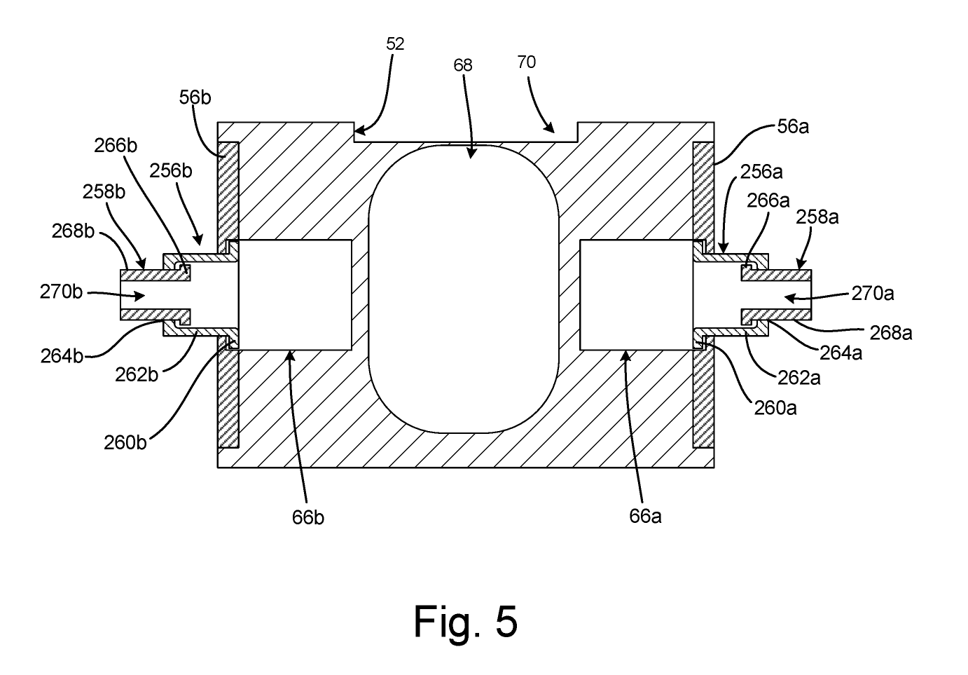

FIG. 5 is a cross-sectional view of piston 52 and pulls 254a, 254b. Piston 52 includes face plates 56a, 56b; pull chambers 66a, 66b; central slot 68; and axial slot 70. Pulls 254a, 254b include inner sections 256a, 256b and outer sections 258a, 258b. Inner sections 256a, 256b include first outer flanges 260a, 260b; first shafts 262a, 262b; and first inner flanges 264a, 264b. Outer sections 258a, 258b include second outer flanges 266a, 266b; second shafts 268a, 268b; and attachment bores 270a, 270b.

Piston 52 is configured to reciprocate within a housing, such as housing 28 (FIGS. 1-3), to pull fluid displacement components, such as fluid displacement components 44a, 44b (FIGS. 2A-2B), fluid displacement components 144a, 144b (FIG. 3), and fluid displacement components 244a, 244b (FIG. 4), through suction strokes. Face plates 56a, 56b are attached to opposite ends of piston 52 and enclose pull chambers 66a, 66b. Pulls 54a, 54b are configured to transmit tensile forces but not compressive forces, such that piston 52 can pull the fluid displacement components via pulls 254a, 254b, but cannot push the fluid displacement components via pulls 254a, 254b.

Inner sections 256a, 256b are at least partially retained within pull chambers 66a, 66b by face plates 56a, 56b. First outer flanges 260a, 260b project from first shafts 262a, 262b and are disposed within pull chambers 66a, 66b. First shafts 262a, 262b extend through openings in face plates 56a, 56b and are configured to slide within the openings in face plates 56a, 56b. First outer flanges 260a, 260b are wider than the openings through face plates 56a, 56b such that first outer flanges 260a, 260b cannot pass through the openings. Instead, first outer flanges 260a, 260b engage the inner sides of face plates 56a, 56b.

First inner flanges 264a, 264b of inner sections 256a, 256b project into a bore through the end of inner sections 256a, 256b disposed opposite first outer flanges 260a, 260b. Outer sections 258a, 258b are configured to slide within inner sections 256a, 256b. Second shafts 268a, 268b extend through the bore defined by first inner flanges 264a, 264b. Second outer flanges 266a, 266b are configured to engage first inner flanges 264a, 264b to prevent outer sections 258a, 258b from sliding out of inner sections 256a, 256b. Attachment bores 270a, 270b are configured to receive attachment members 82 (FIGS. 2A-3) to connect pulls 54a, 54b to the fluid displacement members.

During operation, outer members 258a, 258b are configured to house within inner members 256a, 256b, and inner members 256a, 256b are configured to house within pull chambers 66a, 66b to prevent piston 52 from pushing the fluid displacement members. As such, pulls 54a, 54b are configured to telescope during operation. While pulls 54a, 54b are each shown as including two members that are slidable, it is understood that pulls 54a, 54b can include as many or as few slidable members as desired. Pulls 54a, 54b including multiple slidable members configured to telescope reduces the depth required for pull chambers 66a, 66b to house pulls 54a, 54b. The more compact pull chambers 66a, 66b reduces the footprint of the pump and provides for a more compact pump.

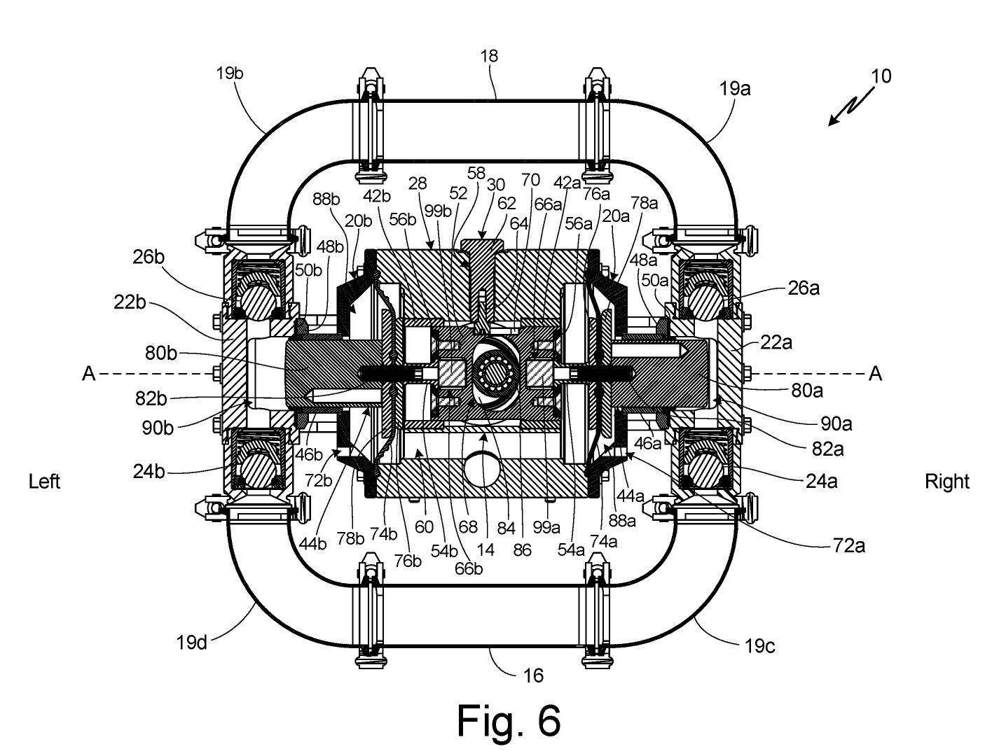

FIG. 6 is a cross-sectional view of pump 10. Pump 10 includes inlet manifold 16; outlet manifold 18; fluid covers 20a, 20b; end covers 22a, 22b; inlet check valves 24a, 24b; outlet check valves 26a, 26b; bushings 42a, 42b; fluid displacement components 44a, 44b; outer cylinders 46a, 36b; collars 48a, 48b; and sealing rings 50a, 50b. Drive system 14 includes housing 28; piston guide 30; piston 52; pulls 54a, 54b; face plates 56a, 56b, and plugs 99a, 99b. Housing 28 includes working fluid inlet 32 and guide opening 58. Housing 28 defines internal pressure chamber 60. Piston guide 30 includes barrel nut 62 and guide pin 64. Piston 52 includes pull chambers 66a, 66b; central slot 68; and axial slot 70. Fluid covers 20a, 20b include, respectively, ports 72a, 72b. Fluid displacement components 44a, 44b include, respectively, diaphragms 74a, 74b; plungers 80a, 80b; attachment members 82a, 82b. Outlet manifold 18 includes elbows 19a, 19b. Inlet manifold 16 includes elbows 19c, 19d. Drive shaft 84 and cam follower 86 of drive 38 are shown.

Pump 10 shown in FIG. 6 is the same as pump 10 shown in FIG. 2B, except pump 10 shown in FIG. 6 includes plugs 99a, 99b. Plugs 99a, 99b are disposed in pull chambers 66a, 66b and are configured to prevent pulls 54a, 54b from sliding within pull chambers 66a, 66b. Instead, plugs 99a, 99b allow piston 52 to transmit compressive, pushing forces to fluid displacement components 44a, 44b such that piston 52 can drive fluid displacement components 44a, 44b through pumping strokes in addition to suction strokes. As such, plugs 99a, 99b enable pump 10 to be easily converted between mechanical/fluid operating mode and a mechanical/mechanical operating mode. In the mechanical/fluid operating mode fluid displacement components 44a, 44b are mechanically pulled through their respective suction strokes and are driven through respective pumping strokes by the charge pressure of the working fluid disposed in internal pressure chamber 60. In the mechanical/mechanical operating mode, fluid displacement components 44a, 44b are mechanically pulled through their respective suction strokes and are also mechanically driven through their respective pumping strokes. When operating in the mechanical/mechanical operating mode, internal pressure chamber 60 does not require a charge of working fluid, as piston 52 drives fluid displacement components 44a, 44b through the pumping strokes.

To convert pump 10 to the mechanical/mechanical operating mode, the user removes face plates 56a, 56b and pulls 54a, 54b, from piston 52 and drops plugs 99a, 99b into pull chambers 66a, 66b. Face plates 56a, 56b and pulls 54a, 54b can then be reinstalled on piston 52.

In some examples, pump 10 includes a pressure switch (not shown) connected to drive system 14. The pressure switch can be configured to switch off drive system 14 based on a sensed pressure reaching or exceeding a threshold. For example, pressure switch can be configured to sense the pressure in pumping chambers 90a, 90b and/or in outlet manifold 18. In the event pump 10 is deadheaded, the pressure will spike in either pumping chambers 90a, 90b and/or outlet manifold 18 as drive 38 causes reciprocation of piston 52. The spike in pressure will trip the pressure switch, causing the pressure switch to deactivate drive 38 while pump 10 is deadheaded. In some examples, the user can reactivate pump 10 after downstream flow is returned. In other examples, the pressure switch can be configured to sense the drop in the process fluid pressure, indicating that downstream flow has returned, and can reactivate pump 10 based on that drop in process fluid pressure.

Pump 10 provides significant advantages. Pump 10 is convertible between the mechanical/fluid operating mode and the mechanical/mechanical operating mode, thereby providing a wide range of pumping options to the end user. The end user can operate in the mechanical/mechanical mode when high downstream pressures are desired or working fluid is unavailable. The end user can operate in the mechanical/fluid operating mode to eliminate downstream pulsation and allow pump 10 to continue operating when deadheaded.

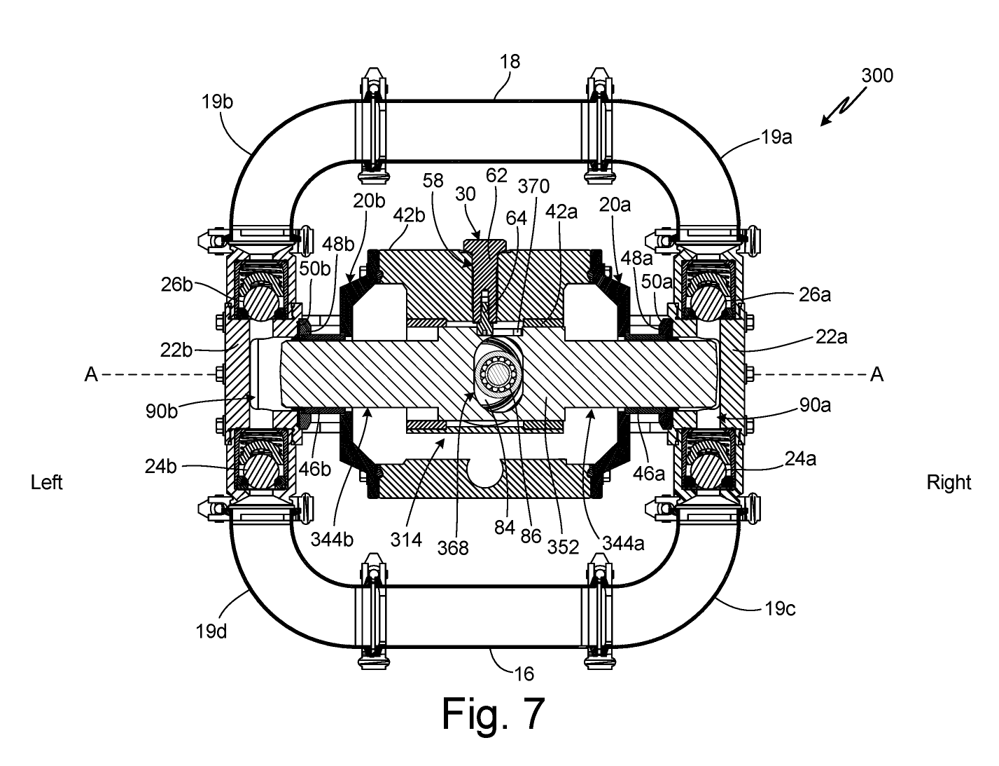

FIG. 7 is a cross-sectional view of pump 300. Pump 300 includes inlet manifold 16; outlet manifold 18; fluid covers 20a, 20b; end covers 22a, 22b; inlet check valves 24a, 24b; outlet check valves 26a, 26b; bushings 42a, 42b; outer cylinders 46a, 46b; collars 48a, 48b; sealing rings 50a, 50b; fluid displacement components 344a, 344b. Drive system 314 includes housing 28, piston guide 30, and piston 352. Housing 28 includes guide opening 58. Piston guide 30 includes barrel nut 62 and guide pin 64. Piston 352 includes central slot 368 and axial slot 370. Outlet manifold 18 includes elbows 19a, 19b. Inlet manifold 16 includes elbows 19c, 19d. Drive shaft 84 and cam follower 86 of drive 38 are shown.

Housing 28 is disposed between fluid covers 20a, 20b. Outer cylinders 46a, 46b are disposed between fluid covers 20a, 20b and end covers 22a, 22b. Inlet manifold 16 is configured to provide process fluid to pumping chambers 90a, 90b within end covers 22a, 22b. Inlet check valves 24a, 24b are disposed between inlet manifold 16 and end covers 22a, 22b. Outlet manifold 18 is configured to receive process fluid from pumping chambers 90a, 90b. Outlet check valves 26a, 26b are disposed between end covers 22a, 22b and outlet manifold 18.

Bushings 42a, 42b are disposed within housing 28 and configured to support piston 352. Piston 352 is disposed within bushings 42a, 42b and is configured to reciprocate along pump axis A-A. Piston guide 30 prevent piston 352 from rotating about pump axis A-A. Barrel nut 62 is disposed in guide opening 58, and guide pin 64 is connected to barrel nut 62 and extends into and engages axial slot 370. Fluid displacement component 344a extends from a first side of piston 352, through outer cylinder 46a, and into pumping chamber 90a within end cover 22a. Fluid displacement component 344b extends from a second side of piston 352, through outer cylinder 46b, and into pumping chamber 90b within end cover 22b. As shown, fluid displacement components 344a, 344b are integrally formed with piston 352. It is understood, however, that fluid displacement components 344a, 344b can be formed separately from piston 352 and joined with piston 352 in any desired manner, such as by a fastener similar to attachment members 82a, 82b (FIGS. 2A-3).

Fluid displacement components 344a, 344b and piston 352 are configured to reciprocate as a single assembly. Piston 352 is configured to drive fluid displacement components 344a, 344b through both their respective suctions strokes and pumping strokes. During a suction stroke, piston 352 retracts fluid displacement component 344a, 344b from fluid cavity 90a, 90b to increase a volume of fluid cavity 90a, 90b, creating suction in fluid cavity 90a, 90b and drawing process fluid into fluid cavity 90a, 90b through inlet valve 24a, 24b. During a pumping stroke, piston 352 drives fluid displacement component 344a, 344b into fluid cavity 90a, 90b to decrease a volume of fluid cavity 90a, 90b and drive the process fluid out of fluid cavity 90a, 90b through outlet valve 26a, 26b.

While pump 300 is shown as including fluid displacement components 344a, 344b, it is understood that pump 300 can include any fluid displacement member suitable for displacing the fluid within pumping chambers 90a, 90b. In one example, pump 300 can include fluid displacement components 44a, 44b (best seen in FIG. 2B), with diaphragms 74a, 74b (best seen in FIG. 2B) rigidly connected to piston 352 such that piston 352 drives fluid displacement components 44a, 44b through both suction and pumping strokes. In other examples, pump 300 can include fluid displacement components 144a, 144b (FIG. 3) or fluid displacement components 244a, 244b (FIG. 4) rigidly connected to piston 352 such that piston 352 drives fluid displacement components 144a, 144b or fluid displacement components 244a, 244b through both suction and pumping strokes.

Pump 300 provides significant advantages. Drive system 314 mechanically drives fluid displacement components 344a, 344b through both suction and pumping strokes. Mechanically driving fluid displacement components 344a, 344b provides increased efficiency by eliminating working fluids. As such, pump 300 can be utilized at locations where compressed air and/or hydraulic fluid is not readily available. In addition, fluid displacement components 344a, 344b being configured as pistons allows pump 300 to generate higher pumping pressures as compared to mechanically-driven diaphragms.

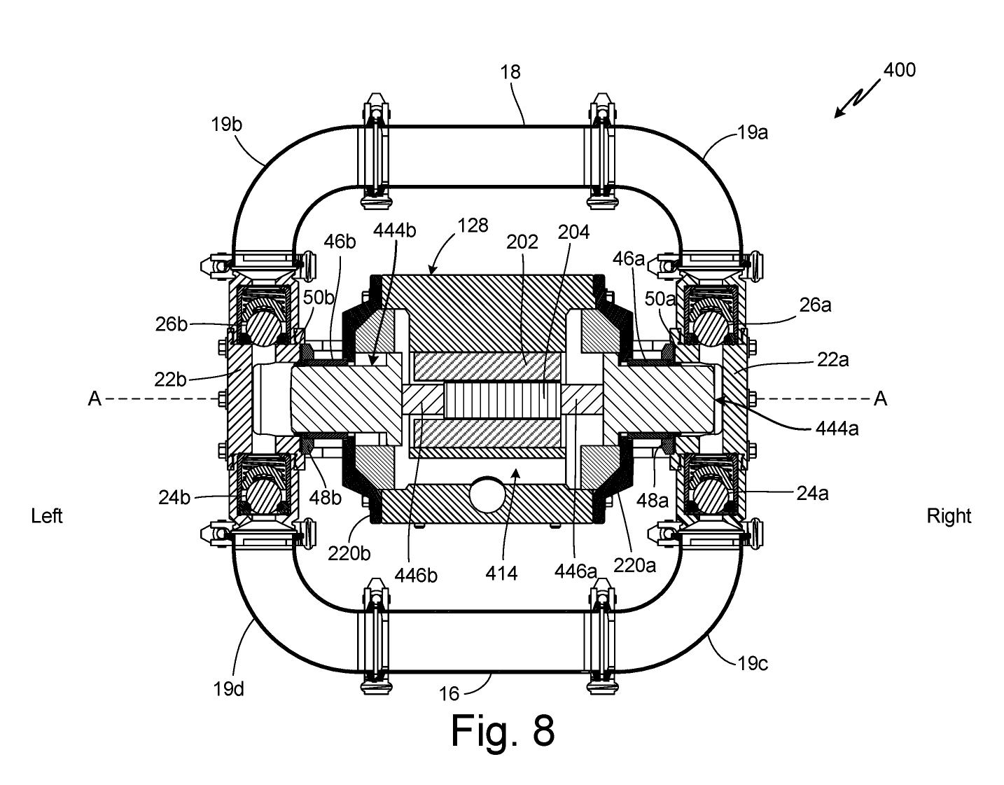

FIG. 8 is a cross-sectional view of pump 400. Pump 400 includes inlet manifold 16; outlet manifold 18; end covers 22a, 22b; inlet check valves 24a, 24b; outlet check valves 26a, 26b; outer cylinders 46a, 46b; collars 48a, 48b; sealing rings 50a, 50b; fluid covers 220a, 220b; and fluid displacement components 444a, 444b. Drive system 414 includes housing 128, solenoid 202, armature 204, and intermediate members 446a, 446b. Outlet manifold 18 includes elbows 19a, 19b. Inlet manifold 16 includes elbows 19c, 19d.

Pump 400 shown in FIG. 8 is substantially similar to pump 200 shown in FIG. 4, except pump 400 shown in FIG. 8 includes armature 204 that is rigidly connected to fluid displacement components 444a, 444b by intermediate members 446a, 446b. Fluid displacement components 444a, 444b are substantially similar to fluid displacement components 244a, 244b. Armature 204 is rigidly connected to fluid displacement components 444a, 444b such that armature 204 drives fluid displacement components 444a, 444b through both the suction and pumping strokes. Intermediate members 446a, 446b can be any desired component capable of transmitting forces both in tension and in compression. For example, intermediate members 446a, 446b can be threaded members configured to engage with threaded bores on both armature 204 and fluid displacement components 444a, 444b. In other examples, intermediate members 446a, 446b can be pinned to armature 204 and fluid dispensing components 444a, 444b; can be formed integrally with one or both of fluid dispensing components 444a, 444b and armature 204; or can provide a rigid connection in any other manner suitable for transmitting both compressive and tensile forces between armature 204 and fluid displacement components 444a, 444b.

Solenoid 202 is configured to drive armature 204 along pump axis A-A to cause armature 204 to drive fluid displacement components 444a, 444b through the suction and pumping strokes. The current supplied to solenoid 202 is configured to prevent overpressurization in the event that pump 400 is deadheaded during operation. The current is sufficient to drive armature 204. However, when pumping chambers 90a, 90b are pressurized during the deadhead event, the process fluid pressure acts on fluid displacement components 444a, 444b and resists movement of armature 204 and overcomes the driving force provided by solenoid 202. As such, the output pressure capable of being produced by pump 400 is dependent on the current powering solenoid 202 and the surface area of fluid displacement component 444a, 444b impacting the process fluid.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A pump for pumping a process fluid, the pump comprising:
a housing defining an internal pressure chamber, the internal pressure chamber configured to contain a working fluid;
a reciprocating member disposed within the internal pressure chamber;
a fluid displacement component having a first surface and a second surface, the first surface configured to contact the working fluid and the second surface configured to contact the process fluid, wherein the fluid displacement component is configured such that pressure exerted on the first surface by the working fluid moves the second surface in a first direction towards the process fluid to expel the process fluid downstream, and wherein the area of the first surface is greater than the area of the second surface; and
a pull extending between the reciprocating member and the fluid displacement component, the pull mechanically transferring a pulling force from the reciprocating member to the fluid displacement component to move the fluid displacement component in a second direction that is the opposite of the first direction, wherein the pull does not mechanically transfer a pushing force from the reciprocating member to the fluid displacement component when the reciprocating member moves in the first direction.

2. The pump of claim 1, wherein the reciprocating member is a piston.

3. The pump of claim 1, further comprising:
an electric motor; and
a drive system connecting the electric motor and the reciprocating member;
wherein the electric motor reciprocates the reciprocating member via the drive system.

4. The pump of claim 1, wherein the fluid displacement component comprises a diaphragm that defines the first surface.

5. The pump of claim 4, wherein the fluid displacement component further comprises a plunger attached to the diaphragm, the plunger defining the second surface.

6. The pump of claim 5, further comprising:
a fluid cover attached to a first end of the housing, wherein a circumferential edge of the diaphragm is retained between the first end of the housing and the fluid cover; and
an end cover defining a process fluid flowpath;
wherein the plunger extends through the fluid cover and into the end cover.

7. The pump of claim 6, wherein the internal pressure chamber is disposed on a side of the diaphragm comprising the first surface, and wherein an outer chamber is disposed between the diaphragm and the fluid cover.

8. The pump of claim 6, further comprising:
a cylinder extending between and mounted on the fluid cover and the end cover;
wherein the plunger extends through the cylinder and is configured to reciprocate within the cylinder.

9. The pump of claim 1, wherein:
the reciprocating member includes a pull chamber;
the pull includes a pull shaft extending out of the pull chamber and connected to the fluid displacement component, and a flange disposed at a first end of the pull shaft within the pull chamber; and
the flange is retains the first end of the pull shaft within the pull chamber.

10. The pump of claim 1, wherein the pull is a flexible member configured to transfer tensile forces but bend in response to compressive forces.

11. The pump of claim 1, further comprising:
a solenoid disposed within housing;
wherein the reciprocating member comprises an armature disposed within the solenoid; and
wherein the solenoid is a double-acting solenoid.

12. The pump of claim 1, wherein the fluid displacement component comprises a piston defining the first surface.

13. The pump of claim 12, wherein the fluid displacement component further comprises a plunger connected to and extending from the piston, wherein the plunger defines the second surface.

14. The pump of claim 13, wherein the first piston has a first diameter and the second piston has a second diameter, the first diameter being larger than the second diameter.

15. The pump of claim 14, further comprising:
a fluid cover attached to a first end of the housing, wherein a circumferential edge of the diaphragm is retained between the first end of the housing and the fluid cover; and
an end cover defining a process fluid flowpath;
wherein the plunger extends through the fluid cover and into the end cover.

16. The pump of claim 15, further comprising:
a first cylinder extending between the fluid cover and the housing, wherein the piston is disposed within the first cylinder; and
a second cylinder extending between the end cover and the fluid cover, wherein the plunger is disposed within the second cylinder.

17. The pump of claim 16, wherein the internal pressure chamber is disposed on a side of the piston comprising the first surface, and wherein an outer chamber is disposed between the piston and the fluid cover.

18. A pump for pumping a process fluid, the pump comprising:
a housing defining an internal pressure chamber, the internal pressure chamber configured to contain a working fluid;
a reciprocating member;
a fluid displacement component having a first surface and a second surface, the first surface configured to contact the working fluid and the second surface configured to contact the process fluid, wherein the fluid displacement component is configured such that pressure exerted on the first surface by the working fluid moves the second surface in a first direction to expel the process fluid, and wherein the area of the first surface is greater than the area of the second surface; and
a pull that links the reciprocating member to the fluid displacement component, the pull mechanically transferring a pulling force from the reciprocating member to the fluid displacement component to move the fluid displacement component in a second direction.

19. The pump of claim 18, further comprising:
a diaphragm that is configured to be moved by a working fluid, wherein the diaphragm defines the first surface; and
a plunger that is attached to the diaphragm to move with the diaphragm as the diaphragm is moved by the working fluid, wherein the plunger defines the second surface;
wherein the movement of the plunger drives the process fluid.

20. The pump of claim 19, wherein the diaphragm is isolated from the process fluid such that the diaphragm does not contact the process fluid.
